(19) United States
(12) Patent Application Publication
(10) Pub. No.: US 2012/0236207 A1
(43) Pub. Date: Sep. 20, 2012

(54) Liquid Crystal Display Device, Liquid Crystal Television Set, and Television Set

(75) Inventor: Yutaka FUKUDA, Daito-shi (JP)

(73) Assignee: Funai Electric Co., Ltd., Daito-shi (JP)

(21) Appl. No.: 13/412,227

(22) Filed: Mar. 5, 2012

(30) Foreign Application Priority Data
Mar. 14, 2011 (JP) 2011-54953

(51) Int. Cl. H04N 5/44; G02F 1/13357

(52) U.S. Cl. 348/725; 349/65; 349/58; 348/E05.096

(57) ABSTRACT

This liquid crystal display device includes a display portion, a board portion having a mounting surface on which light sources are mounted, a light guide plate including a first end surface receiving light from the light sources, guiding the light received from the first end surface to the display portion, and spacer members made of an inelastic material, so arranged as to be in contact with the mounting surface of the board portion and the first end surface of the light guide plate.

### BACKGROUND OF THE INVENTION

1. Field of the Invention

The present invention relates to a liquid crystal display device, a liquid crystal television set, and a television set, and more particularly, it relates to a liquid crystal display device, a liquid crystal television set, and a television set each including a display portion, a board portion mounted with a light source, and a light guide plate guiding light from the light source to the display portion.

2. Description of the Background Art

A liquid crystal display device or the like including a display portion, a board portion mounted with a light source, and a light guide plate guiding light from the light source to the display portion is known in general, as disclosed in Japanese Patent Laying-Open No. 2008-16433, for example.

Japanese Patent Laying-Open No. 2008-16433 discloses a liquid crystal device including a liquid crystal panel, a holding frame (frame) holding the liquid crystal panel, a plurality of LED light sources aligned along the inner surface of the holding frame on one side (lower side), and a light guide plate guiding light from the LED light sources to the liquid crystal panel, arranged above the LED light sources on the back side of the liquid crystal panel. In the liquid crystal device according to the aforementioned Japanese Patent Laying-Open No. 2008-16433, a spacer member made of an elastic material is arranged between the aligned LED light sources. Thus, the light guide plate is held through the spacer member on a board mounted with the LED light sources in a state where clearances are formed between the light-emitting surfaces of the LED light sources and the light-receiving surface of the light guide plate. The end surface of the light guide plate opposite to the light-receiving surface is pressed into the inner surface of the holding frame on another side (upper side) by elastic force of the spacer member made of the elastic material. Thus, the light guide plate arranged in the holding frame is vertically positioned.

In the liquid crystal device according to Japanese Patent Laying-Open No. 2008-16433, however, the light guide plate may expand (thermally expand) by heat generated from the LED light sources or changes in temperature conditions and humidity conditions where the liquid crystal device is placed. In this case, the position of the end surface of the light guide plate opposite to the light-receiving surface is regulated by the inner surface of the holding frame on another side (upper side), and hence the light guide plate expands so that the spacer member made of the elastic material coming into contact with the light-receiving surface is pressed downward to be deformed. Consequently, the clearances between the light-emitting surfaces of the LED light sources and the light-receiving surface of the light guide plate are not maintained substantially constant. Especially in a liquid crystal device having a large screen, a light guide plate significantly expands/contracts, and LED light sources may come into contact with the light-receiving surface of the light guide plate to be damaged when clearances between the LED light sources and the light guide plate disappear. Furthermore, a distance between the LED light sources and the light-receiving surface of the light guide plate may be too large when the clearances are provided in consideration of only the amount of expansion and contraction of the light guide plate. The too large clearances may result in a reduction in luminance or unevenness of light emission of backlight emitted from the light guide plate. Thus, also in the liquid crystal device having the large screen, minimum necessary and proper clearances are required.

### SUMMARY OF THE INVENTION

The present invention has been proposed in order to solve the aforementioned problem, and an object of the present invention is to provide a liquid crystal display device, a liquid crystal television set, and a television set each capable of keeping the size of each of clearances between light sources and a light guide plate proper and substantially constant.

A liquid crystal display device according to a first aspect of the present invention includes a display portion, a board portion having a mounting surface on which light sources are mounted, a light guide plate including a first end surface receiving light from the light sources, guiding the light received from the first end surface to the display portion, and spacer members made of an inelastic material, so arranged as to be in contact with the mounting surface of the board portion and the first end surface of the light guide plate.

As hereinabove described, the liquid crystal display device according to the first aspect of the present invention includes the spacer members made of the inelastic material, so arranged as to be in contact with the mounting surface of the board portion and the first end surface of the light guide plate, whereby the spacer members are made of the inelastic material so that the same are not substantially deformed by pressing force received from the light guide plate even if the light guide plate thermally expands by heat generated from the light sources or the like to generate the outward pressing force. In other words, a distance (clearance) between the mounting surface of the board portion and the first end surface of the light guide plate can be maintained substantially constant due to the spacer members that are not substantially deformed, interposed between the board portion and the light guide plate. Furthermore, the spacer members are not substantially deformed so that the size of the clearance between the mounting surface of the board portion and the first end surface of the light guide plate can be properly maintained in response to the dimensions of the light guide plate. Thus, the light incidence efficiency of the light emitted from the light sources can be improved. Furthermore, the spacer members render the clearance between the board portion and the light guide plate proper, and hence the luminance of backlight emitted from the light guide plate can be maintained at a proper level while unevenness of light emission of the backlight can be inhibited.

In the aforementioned liquid crystal display device according to the first aspect, the light guide plate is preferably so formed as to press the spacer members made of the inelastic material against the mounting surface of the board portion. According to this structure, the pressing force directed from the light guide plate toward the mounting surface of the board portion can bring the first end surface of the light guide plate into contact with the spacer members without rattling. Furthermore, this pressing force can bring the spacer members into contact with the mounting surface of the board portion without rattling. Consequently, the clearance having the substantially constant size, provided between the mounting surface of the board portion and the first end surface of the light guide plate can be reliably maintained.

In this case, the board portion is preferably arranged below the light guide plate, and the light guide plate is preferably so formed as to press the spacer members made of the inelastic material against the mounting surface of the board portion by its own weight. According to this structure, the weight of the light guide plate can be utilized to easily generate the pressing force directed from the light guide plate toward the mounting surface of the board portion. In other words, no urging member to urge the light guide plate against the spacer members may be provided separately, and hence the structure of the liquid crystal display device can be simplified.

In the aforementioned liquid crystal display device according to the first aspect, each of the light sources preferably has a light-emitting surface on a side opposed to the first end surface of the light guide plate, and an interval between the light-emitting surface of each of the light sources and the first end surface of the light guide plate is preferably smaller than a height from the mounting surface to the light-emitting surface of each of the light sources. According to this structure, light spreading and travelling from the light sources toward the light guide plate can be inhibited from widely leaking into the sides of the spacer members, and hence the light emitted from the light sources can efficiently enter (be incident on) the first end surface of the light guide plate opposed to the light-emitting surfaces of the light sources.

In the aforementioned liquid crystal display device according to the first aspect, the spacer members are preferably arranged on end sides of the light guide plate and in a vicinity of a central portion of the light guide plate. According to this structure, the light guide plate can be stably supported by the spacer members arranged at least on the end sides of the light guide plate and in the vicinity of the central portion of the light guide plate. Therefore, the clearance between the board portion and the light guide plate can be maintained substantially constant from one end of the light guide plate to the other end thereof.

In the aforementioned liquid crystal display device according to the first aspect, each of the spacer members is preferably arranged between the light sources. According to this structure, the size of the clearance between the board portion and the light guide plate in a direction substantially perpendicular to the first end surface can be properly maintained between the light sources.

In the aforementioned liquid crystal display device according to the first aspect, a length of each of the spacer members along a longitudinal direction in which the first end surface of the light guide plate extends is preferably smaller than a length of each of the light sources along the longitudinal direction. According to this structure, contact areas between spacer members and the light guide plate can be reduced, and hence some part of light travelling into the light guide plate can be inhibited from being actively reflected on contact interfaces between the light guide plate and the spacer members. Consequently, the light reflection on the contact interfaces can be inhibited from influencing the quality (luminance or presence/absence of unevenness of light emission) of the backlight.

In the aforementioned liquid crystal display device according to the first aspect, the light guide plate is preferably in contact with the spacer members so as to be movable in a longitudinal direction of the first end surface of the light guide plate. According to this structure, positions of the spacer members with respect to the mounting surface can be inhibited from deviation resulting from deformation of the light guide plate even if the light guide plate thermally expands to be deformed. Thus, the size of each of the clearance between the board portion and the light guide plate can be properly maintained even if the light guide plate thermally expands to be deformed.

The aforementioned liquid crystal display device according to the first aspect preferably further includes a first chassis including a recess portion surrounded by an inner surface of the first chassis, holding the board portion and the light guide plate on a bottom surface of the recess portion, the light guide plate preferably further includes a second end surface formed on a side opposite to the first end surface, and the second end surface of the light guide plate is preferably separated from the inner surface of the first chassis opposed to the second end surface at a prescribed interval in a state where the light guide plate is arranged on the mounting surface of the board portion through the spacer members. According to this structure, a clearance provided between the second end surface of the light guide plate and the inner surface of the first chassis corresponding to this second end surface can accommodate expansion of the light guide plate even if the light guide plate thermally expands by the heat generated from the light sources or the like. Consequently, internal stress exceeding a prescribed amount can be inhibited from being generated in the light guide plate. Furthermore, the light guide plate can be inhibited from warp or the like resulting from the internal stress.

In this case, the light guide plate preferably further includes a third end surface extending in a direction substantially perpendicular to the first end surface and the second end surface, opposed to the inner surface of the first chassis, and the third end surface of the light guide plate is preferably separated from the inner surface of the first chassis opposed to the third end surface at a prescribed interval in the state where the light guide plate is arranged on the mounting surface of the board portion through the spacer members. According to this structure, a clearance provided between the third end surface of the light guide plate and the inner surface of the first chassis opposed to this third end surface can accommodate expansion of the light guide plate. Consequently, internal stress toward not only the first end surface and the second end surface of the light guide plate but also the third end surface of the light guide plate, exceeding a prescribed amount can be inhibited from being generated in the light guide plate.

The aforementioned structure including the first chassis preferably further includes a second chassis opposed to a front surface of the light guide plate opposite to a back surface of the light guide plate on which the first chassis is arranged, and the light guide plate is preferably so held between the first chassis and the second chassis from a side of the back surface and a side of the front surface as to be fixed between the first chassis and the second chassis in a state where the light guide plate is arranged on the mounting surface through the spacer members on the bottom portion of the recess portion of the first chassis. According to this structure, the light guide plate is held between the first chassis and the second chassis in a state where the clearance between the board portion and the light guide plate is properly maintained, whereby the position of the light guide plate can be fixed. Consequently, the spacer members can be inhibited from positional deviation resulting from vibration or the like during movement of the liquid crystal display device.

In the aforementioned liquid crystal display device according to the first aspect, each of the spacer members preferably includes an arrangement portion arranged on the mounting surface of the board portion and a contact portion in contact with the first end surface of the light guide plate, and a contact area between the contact portion and the first end surface is preferably smaller than an area of the arrangement portion. According to this structure, each of the spacer members can be stably arranged on the mounting surface of the board portion through the larger contact area. Furthermore, each of the spacer members can be brought into contact with the first end surface of the light guide plate through the smaller contact area. Thus, some part of light travelling into the light guide plate can be inhibited from being actively reflected on a contact interface between the first end surface and the contact portion of each of the spacer members. Consequently, the light reflection on the contact interface can be inhibited from influencing the quality (luminance or presence/absence of unevenness of light emission) of backlight.

In the aforementioned structure including the spacer members each including the arrangement portion and the contact portion, the mounting surface of the board portion preferably extends along a longitudinal direction in which the first end surface of the light guide plate extends, and a length of the contact portion of each of the spacer members in the longitudinal direction is preferably smaller than a length of the arrangement portion of each of the spacer members in the longitudinal direction. According to this structure, each of the spacer members can be stably arranged on the mounting surface of the board portion along the longitudinal direction in which the first end surface of the light guide plate extends. Furthermore, light can be easily inhibited from being actively reflected on the contact interface between the first end surface of the light guide plate and the contact portion of each of the spacer members along the longitudinal direction in which the first end surface of the light guide plate extends.

In the aforementioned structure including the spacer members each including the arrangement portion and the contact portion, the contact portion of each of the spacer members is preferably planarized, and the planarized contact portion is preferably in line contact with the first end surface of the light guide plate. According to this structure, the spacer members and the light guide plate can be reliably brought into line contact with each other, whereby the clearance between the board portion and the light guide plate can be reliably secured.

In the aforementioned structure in which the length of the contact portion of each of the spacer members in the longitudinal direction is smaller than the length of the arrangement portion of each of the spacer members in the longitudinal direction, a length of each of the spacer members along a short-side direction orthogonal to the longitudinal direction of the first end surface of the light guide plate is preferably substantially equal to or larger than a thickness of the light guide plate along the short-side direction. According to this structure, the overall first end surface of the light guide plate can be supported by the spacer members along the short-side direction orthogonal to the longitudinal direction of the first end surface of the light guide plate, and hence the clearance between the board portion and the light guide plate can be properly maintained along not only the longitudinal direction but also the short-side direction.

In the aforementioned structure including the spacer members each including the arrangement portion and the contact portion, each of the spacer members preferably has a trapezoidally shaped or triangularly shaped cross-section as viewed along a short-side direction orthogonal to a longitudinal direction in which the first end surface of the light guide plate extends. According to this structure, influence of light reflection on the contact interface between the first end surface of the light guide plate and the contact portion of each of the spacer members can be diminished along the longitudinal direction in which the first end surface of the light guide plate extends.

In the aforementioned structure including the spacer members each including the arrangement portion and the contact portion, each of the spacer members preferably has an inverted T-shaped cross-section as viewed along a short-side direction orthogonal to a longitudinal direction of the light guide plate, and the contact portion is preferably provided on a tip of a support portion extending from the arrangement portion toward the first end surface of the light guide plate. According to this structure, influence of light reflection on the contact interface between the first end surface of the light guide plate and the contact portion of each of the spacer members can be diminished along the longitudinal direction in which the first end surface of the light guide plate extends.

In the aforementioned liquid crystal display device according to the first aspect, the spacer members are preferably in direct contact with either one of the mounting surface of the board portion and the first end surface of the light guide plate while each of the spacer members is bonded to the other one of the mounting surface of the board portion and the first end surface of the light guide plate through a bonding layer. According to this structure, each of the spacer members previously bonded onto either one of the mounting surface of the board portion and the first end surface of the light guide plate through the bonding layer can be easily brought into contact with the other one of the mounting surface of the board portion and the first end surface of the light guide plate so that the liquid crystal display device can be easily assembled, and hence an operation of assembling the liquid crystal display device can be simplified.

A liquid crystal television set according to a second aspect of the present invention includes a receiving portion receiving a television broadcast signal, a display portion displaying an image on the basis of the television broadcast signal received by the receiving portion, a board portion having a mounting surface on which light sources are mounted, a light guide plate including a first end surface receiving light from the light sources, guiding the light received from the first end surface to the display portion, and spacer members made of an inelastic material, so arranged as to be in contact with the mounting surface of the board portion and the first end surface of the light guide plate.

As hereinabove described, the liquid crystal television set according to the second aspect of the present invention includes the spacer members made of the inelastic material, so arranged as to be in contact with the mounting surface of the board portion and the first end surface of the light guide plate, whereby the spacer members are made of the inelastic material so that the same are not substantially deformed by pressing force received from the light guide plate even if the light guide plate thermally expands by heat generated from the light sources or the like to generate the outward pressing force. In other words, a distance (clearance) between the mounting surface of the board portion and the first end surface of the light guide plate can be maintained substantially constant due to the spacer members that are not substantially deformed, interposed between the board portion and the light guide plate. Furthermore, the spacer members are not substantially deformed so that the size of the clearance between the mounting surface of the board portion and the first end surface of the light guide plate can be properly maintained in response to the dimensions of the light guide plate. Thus, the light incidence efficiency of the light emitted from the light sources can be improved. Furthermore, the spacer members render the clearance between the board portion and the light guide plate proper, and hence the luminance of backlight emitted from the light guide plate can be maintained at a proper level while unevenness of light emission of the backlight can be inhibited.

A television set according to a third aspect of the present invention includes a receiving portion receiving a television broadcast signal, a display portion displaying an image on the basis of the television broadcast signal received by the receiving portion, a board portion having a mounting surface on which light sources are mounted, and a light guide plate including a first end surface receiving light from the light sources, guiding the light received from the first end surface to the display portion, and spacer members made of an inelastic material, so arranged as to be in contact with the mounting surface of the board portion and the first end surface of the light guide plate.

As hereinabove described, the television set according to the third aspect of the present invention includes the spacer members made of the inelastic material, so arranged as to be in contact with the mounting surface of the board portion and the first end surface of the light guide plate, whereby the spacer members are made of the inelastic material so that the same are not substantially deformed by pressing force received from the light guide plate even if the light guide plate thermally expands by heat generated from the light sources or the like to generate the outward pressing force. In other words, a distance (clearance) between the mounting surface of the board portion and the first end surface of the light guide plate can be maintained substantially constant due to the spacer members that are not substantially deformed, interposed between the board portion and the light guide plate. Furthermore, the spacer members are not substantially deformed so that the size of the clearance between the mounting surface of the board portion and the first end surface of the light guide plate can be properly maintained in response to the dimensions of the light guide plate. Thus, the light incidence efficiency of the light emitted from the light sources can be improved. Furthermore, the spacer members render the clearance between the board portion and the light guide plate proper, and hence the luminance of backlight emitted from the light guide plate can be maintained at a proper level while unevenness of light emission of the backlight can be inhibited.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing the overall structure of a liquid crystal display device according to an embodiment of the present invention;

FIG. 2 is an exploded perspective view showing the inner structure of a display device body in the liquid crystal display device shown in FIG. 1;

FIG. 3 is a sectional view taken along the line 500-500 of the display device body shown in FIG. 2;

FIG. 4 is a perspective view showing the structure of a light source portion provided in the display device body shown in FIG. 2;

FIG. 5 is a front elevational view showing the structure of a backlight portion in the display device body shown in FIG. 2;

FIG. 6 is a diagram showing the detailed structure of a spacer member interposed between the light source portion and a light guide plate in the backlight portion shown in FIG. 5;

FIG. 7 is a perspective view showing the detailed structure of the spacer member interposed between the light source portion and the light guide plate in the backlight portion shown in FIG. 5;

FIG. 8 is a diagram showing the detailed structure of a spacer member interposed between a light source portion and a light guide plate in a liquid crystal display device according to a first modification of the embodiment of the present invention;

FIG. 9 is a perspective view showing the detailed structure of the spacer member interposed between the light source portion and the light guide plate in a backlight portion shown in FIG. 8;

FIG. 10 is a diagram showing the detailed structure of a spacer member interposed between a light source portion and a light guide plate in a liquid crystal display device according to a second modification of the embodiment of the present invention; and

FIG. 11 is a perspective view showing the detailed structure of the spacer member interposed between the light source portion and the light guide plate in a backlight portion shown in FIG. 10.

### DESCRIPTION OF THE PREFERRED EMBODIMENTS

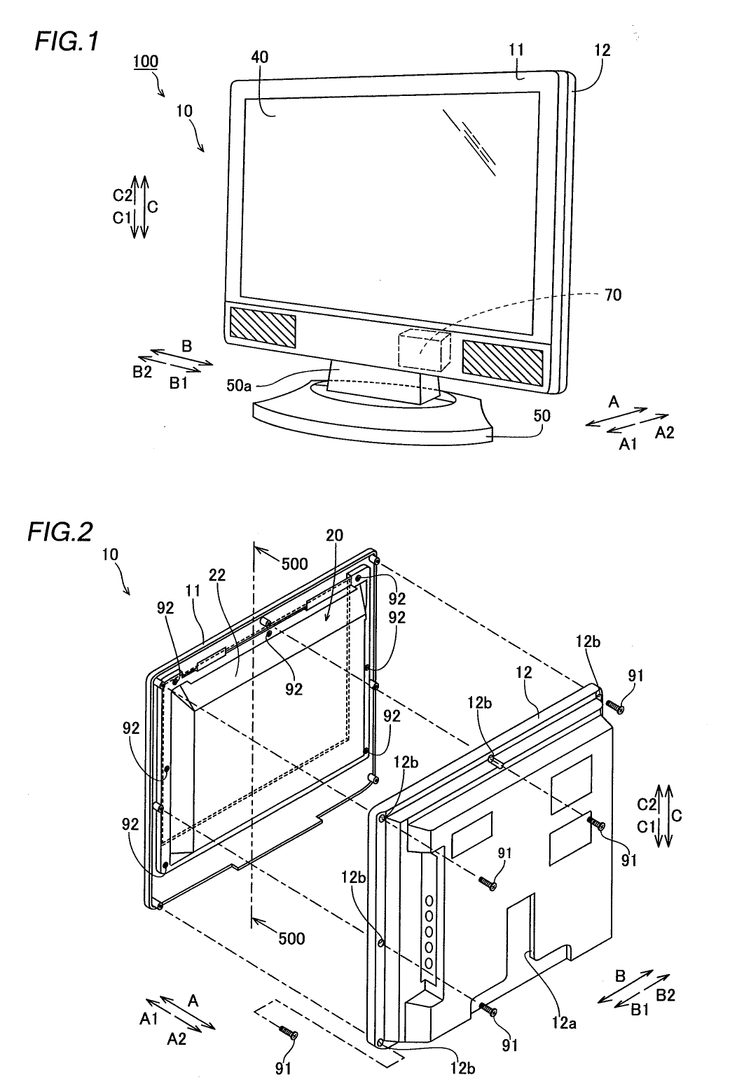

First, the structure of a liquid crystal display device 100 according to the embodiment of the present invention is described with reference to FIGS. 1 to 7. The liquid crystal display device 100 hereinafter illustrated may be a liquid crystal television set having a TV tuner function, a liquid crystal display monitor connected to a PC or the like, or the like.

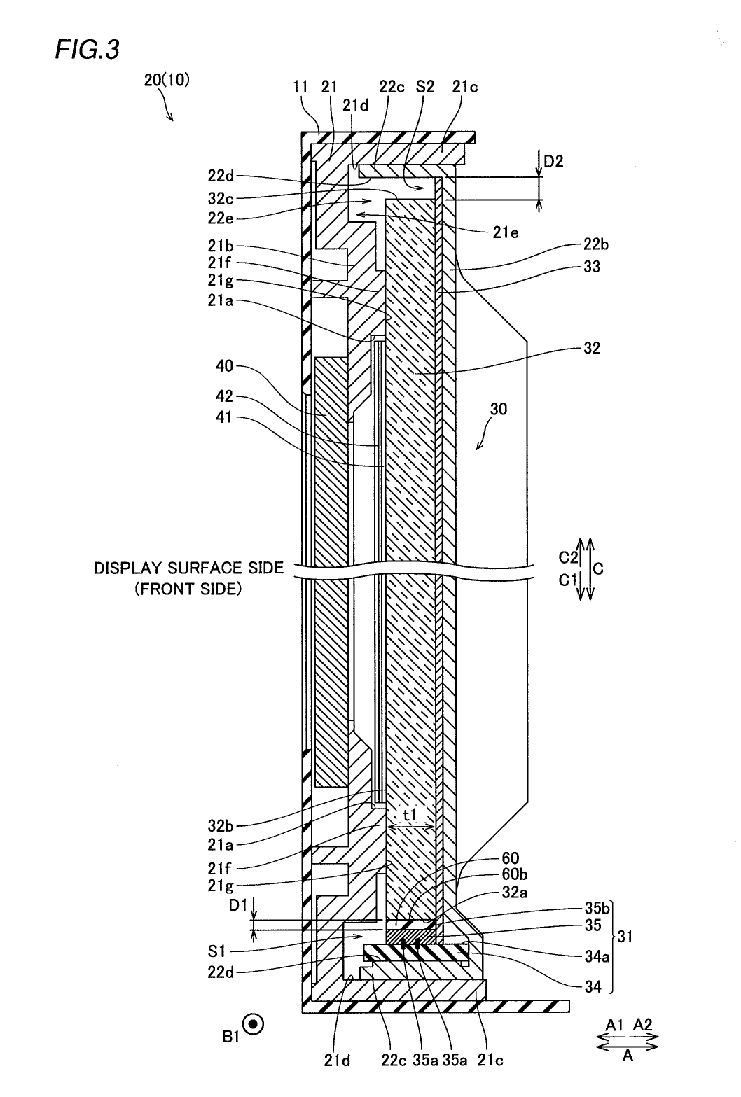

The liquid crystal display device 100 according to the embodiment of the present invention includes a display device body 10 and a stand 50 supporting the display device body 10 to be rotatable in an anteroposterior direction (direction A) and a lateral direction (direction B), as shown in FIG. 1. As shown in FIG. 2, the display device body 10 includes a front cabinet 11 and a rear cabinet 12 both made of resin, and a liquid crystal module 20 arranged between the front cabinet 11 and the rear cabinet 12. The front cabinet 11 is in the form of a frame in which a portion of the front cabinet 11 where a liquid crystal panel 40 (see FIG. 3) is exposed on the front side of the liquid crystal display device 100 is cut out in a substantially rectangular shape. The liquid crystal module 20 is mounted inside the front cabinet 11 with screws 92. The rear cabinet 12 is fixed onto the front cabinet 11 from the back side (A2 side) toward the front side (A1 side) with screws 91. The liquid crystal display device 100 is provided with a tuner 70 receiving a television broadcast signal. The liquid crystal panel 40 is formed to display an image on the basis of the television broadcast signal received by the tuner 70. The liquid crystal panel 40 is an example of the “display portion” in the present invention. The tuner 70 is an example of the “receiving portion” in the present invention.

As shown in FIG. 3, the liquid crystal module 20 includes a front chassis 21 made of metal provided in the form of a frame having four sides and a rear chassis 22 made of metal mounted onto the front chassis 21 from the back side (A2 side) of the front chassis 21 toward the front side (A1 side). The front chassis 21 is arranged on the front surface (in a direction A1) of a light guide plate 32 opposite to the back surface (in a direction A2) of the light guide plate 32 on which the rear chassis 22 is arranged. The rear chassis 22 is an example of the “first chassis” in the present invention. The front chassis 21 is an example of the “second chassis” in the present invention.

The front chassis 21 has a bottom portion 21b having a substantially rectangular opening 21a penetrating in the direction A in the central region thereof and a wall portion 21c standing up in a direction substantially perpendicular to (in the direction A2 with respect to) the bottom portion 21b along the outer periphery of the bottom portion 21b (directions B and C in FIG. 2), as shown in FIG. 3. The front chassis 21 is formed with a recess portion 21e constituted by the inner surface 21d (inner periphery) of the wall portion 21c and the bottom portion 21b to hold the rear chassis 22.

The rear chassis 22 has a substantially flat bottom portion 22b having no opening and a wall portion 22c standing up in a direction substantially perpendicular to (in the direction A1 with respect to) the bottom portion 22b along the outer periphery of the bottom portion 22b (directions B and C in FIG. 2). The rear chassis 22 is formed with a recess portion 22e constituted by the inner surface 22d (inner periphery) of the wall portion 22c and the bottom portion 22b to hold a backlight portion 30 described later. The rear chassis 22 is fixed onto the front chassis 21 with a plurality of screw members (not shown) in a state where the inner surface 21d of the wall portion 21c of the front chassis 21 is fitted into the outer surface (outer periphery) of the wall portion 22c of the rear chassis 22. Thus, a space is formed in a region (region surrounded by the bottom portion 21b and the recess portion 22e) where the bottom portion 21b of the front chassis 21 and the bottom portion 22b of the rear chassis 22 are opposed to each other. This space extends in the direction B (see FIG. 2) that is the lateral direction of the display device body 10 and the direction C that is the vertical direction of the display device body 10 with a prescribed depth in the direction A. The backlight portion 30 is incorporated in this space. The bottom portion 22b is an example of the “bottom surface” in the present invention.

As shown in FIG. 3, the liquid crystal panel 40 is mounted on a portion of the front surface (on the A1 side) of the bottom portion 21b of the front chassis 21 overlapping at least the opening 21a in the direction A. In other words, the opening 21a of the front chassis 21 is blocked with the liquid crystal panel 40. The liquid crystal panel 40 is connected to an unshown control board circuit portion of the display device body 10 (see FIG. 2).

The backlight portion 30 applies light to the back surface (A2 side) of the liquid crystal panel 40 from within the display device body 10. Thus, the liquid crystal panel 40 can be illuminated and display a clear image toward the front side. The backlight portion 30 provided in the liquid crystal module 20 is of an edge light type. In other words, the backlight portion 30 includes a light source portion 31, the light guide plate 32 guiding light from the light source portion 31, and a reflective sheet 33, as shown in FIG. 3. The light source portion 31 is an example of the “board portion” in the present invention. The structure of the backlight portion 30 is now described.

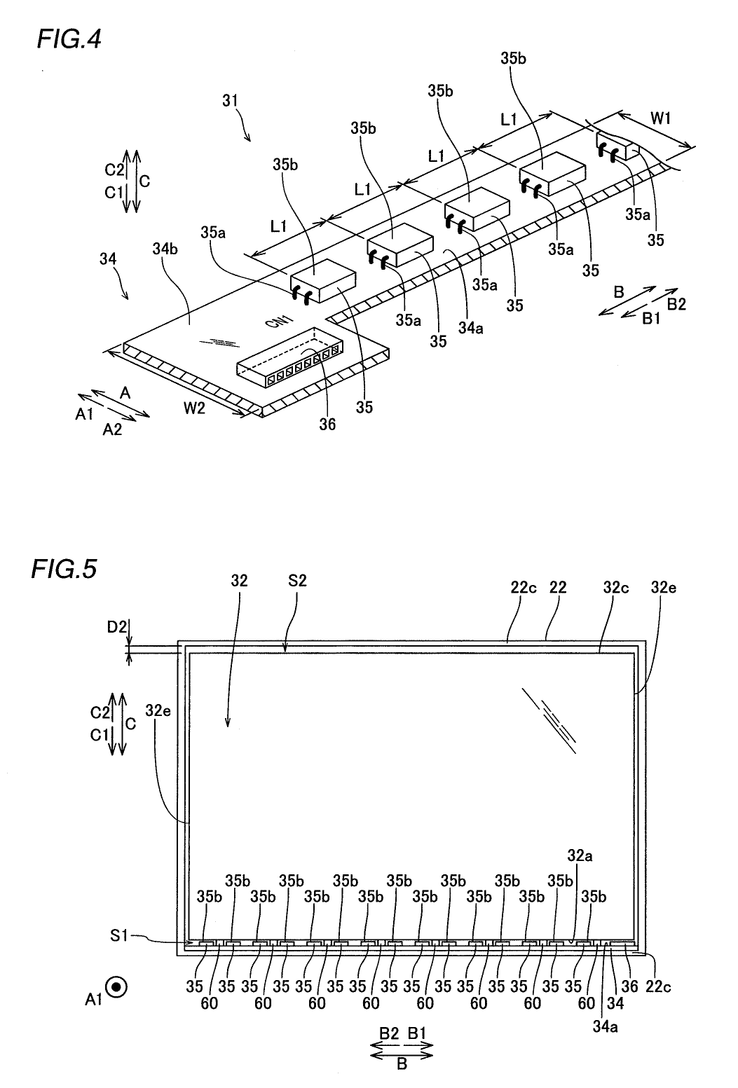

The light source portion 31 is mounted on the inner surface (surface on a C2 side) of the wall portion 22c located on the lower side (C1 side) of the rear chassis 22, as shown in FIG. 3. The light source portion 31 includes a glass epoxy board 34 formed in a prescribed planar shape (substantially L shape) and a plurality of (fifteen in this embodiment) LEDs 35 arranged linearly on a mounting surface 34a of the glass epoxy board 34, as shown in FIG. 4. The plurality of LEDs 35 are mounted at substantially equal intervals L1 along a longitudinal direction (direction B) in which the glass epoxy board 34 extends. The LEDs 35 have lead terminals 35a. The LED light emitting surfaces 35b of the LEDs 35 each have a substantially rectangular shape. The lead terminals 35a exposed from side surfaces of the LEDs 35 different from the emitting surfaces 35b are bent downwardly about 90 degrees to pass through the mounting surface 34a and be connected to printed circuitry inside the glass epoxy board 34. The direction A and the direction B are examples of the “short-side direction” and the “longitudinal direction” in the present invention, respectively. The emitting surfaces 35b are examples of the “light-emitting surface” in the present invention.

As shown in FIG. 4, a wider portion 34b having a width W2 larger than the width W1 of a region where the LEDs 35 are mounted in the short-side direction (direction A) is provided in an end region of the glass epoxy board 34 on one side (B1 side). A connector 36 made of resin is mounted on the mounting surface 34a of the wider portion 34b. In the light source portion 31, each terminal (not shown) of the connector 36 is connected to each of the LEDs 35 by a wire. A connecting wire extending from the unshown control board circuit portion of the display device body 10 (see FIG. 2) is connected to the connector 36, whereby the plurality of LEDs 35 emit light with a prescribed luminance. The LEDs 35 are examples of the “light source” in the present invention.

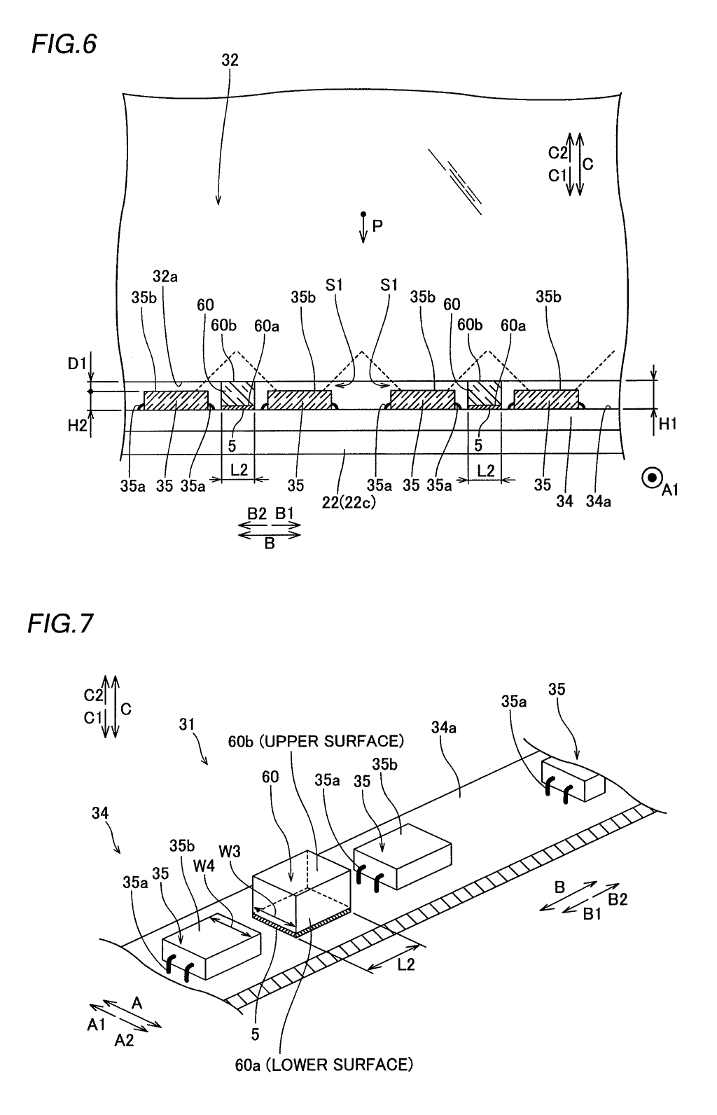

The light guide plate 32 is made of a transparent acrylic resin allowing transmission of light and formed in a plate-like shape with a thickness t1 (in the direction A), as shown in FIG. 3. The light guide plate 32 has a substantially rectangular shape in plan view, as shown in FIG. 5. The light guide plate 32 is so formed as to be fitted into the recess portion 22e of the rear chassis 22 through the reflective sheet 33 mounted on the inner surface (on the side of the recess portion 22e) of the bottom portion 22b of the rear chassis 22. As shown in FIG. 3, the end surface of the light guide plate 32 on the lower side (C1 side) having the thickness t1 is a light-receiving surface 32a. This light-receiving surface 32a extends from one end of the light guide plate 32 to the other end thereof along the direction B (direction perpendicular to the plane of FIG. 3). The front surface (on the A1 side) of the light guide plate 32 extending in a direction (direction C) orthogonal to the light-receiving surface 32a is a light-emitting surface 32b. The light guide plate 32 is arranged above (on the C2 side of) the light source portion 31 at a prescribed interval D1 (see FIGS. 3 and 6) with respect to the light source portion 31 mounted on the inner surface (on the C1 side) of the wall portion 22c of the rear chassis 22. Thus, light emitted from the LEDs 35 (emitting surfaces 35b) is incident on the light-receiving surface 32a of the light guide plate 32 arranged above at the interval D1. Then, the light is repetitively multiply-reflected by the reflective sheet 33 to be emitted from the light-emitting surface 32b of the light guide plate 32 to the liquid crystal panel 40 located on the front side. The LEDs 35 have the emitting surfaces 35b on a side (C2 side) opposed to the light-receiving surface 32a of the light guide plate 32. The light-receiving surface 32a is an example of the “first end surface” in the present invention.

According to this embodiment, a plurality of (eight) spacer members 60 made of a transparent acrylic resin allowing transmission of light that is an inelastic material are provided on the mounting surface 34a of the glass epoxy board 34 of the light source portion 31, as shown in FIGS. 5 and 6.

More specifically, the spacer members 60 each have a substantially rectangular parallelepiped shape, and a lower surface portion 60a and an upper surface portion 60b formed substantially parallel to each other, as shown in FIG. 7. The length of each of the lower surface portion 60a and the upper surface portion 60b in the longitudinal direction (direction B) is L2, and the length thereof in the short-side direction (direction A) is W3. The length L2 of each of the spacer members 60 along the longitudinal direction (direction B) in which the light-receiving surface 32a of the light guide plate 32 extends is smaller than the length (length from the end surface on the B1 side to the end surface on a B2 side) of each of the LEDs 35 along the longitudinal direction. The length W3 of each of the spacer members 60 in the direction A is substantially equal to the width W4 of each of the LEDs 35 in the direction A. The length W3 of each of the spacer members 60 along the short-side direction (direction A) orthogonal to the longitudinal direction (direction B) of the light-receiving surface 32a of the light guide plate 32 is substantially equal to the thickness t1 of the light guide plate 32. As shown in FIG. 6, the lower surface portion 60a of each of the spacer members 60 is fixed onto the mounting surface 34a between the adjacent LEDs 35 with a double-faced adhesive tape 5. The thickness (in the direction C) of the double-faced adhesive tape 5 is very small, and hence the double-faced adhesive tape 5 hardly expands/contracts in a thickness direction. Therefore, a state where each of the spacer members 60 is fixed onto the mounting surface 34a is hardly different from a state where the lower surface portion 60a of each of the spacer members 60 is in contact with the mounting surface 34a. In FIG. 6, the thickness of the double-faced adhesive tape 5 is slightly exaggeratingly illustrated for convenience of illustration. The lower surface portion 60a and the upper surface portion 60b are examples of the “arrangement portion” and the “contact portion” in the present invention, respectively. The double-faced adhesive tape 5 is an example of the “bonding layer” in the present invention.

The spacer members 60 are arranged on the end sides of the light guide plate 32 in the longitudinal direction (direction B) and in the vicinity of a central portion of the light guide plate 32. Furthermore, the spacer members 60 are arranged between the LEDs 35.

The height H1 (in the direction C) of each of the spacer members 60 from the lower surface portion 60a to the upper surface portion 60b is larger than a height H2 from the mounting surface 34a to the emitting surfaces 35b (C2 side) of the LEDs 35 (H1>H2). Thus, the light guide plate 32 is placed on the mounting surface 34a of the glass epoxy board 34 through the spacer members 60 in a state where the upper surface portion 60b of each of the spacer members 60 is in contact with the light-receiving surface 32a of the light guide plate 32. In other words, clearances S1 each having the distance D1 (=H1−H2) are provided between the emitting surfaces 35b of the LEDs 35 and the light-receiving surface 32a of the light guide plate 32. The interval D1 between the emitting surfaces 35b of the LEDs 35 and the light-receiving surface 32a of the light guide plate 32 is smaller than the height H2 from the mounting surface 34a to the emitting surfaces 35b of the LEDs 35. The minimum value of each of the clearances S1 (distance D1) is preferably about 0.3 mm. The upper limit of each of the clearances S1 is determined by the size (length×width) of the display device body 10 including the light guide plate 32. According to this embodiment, the spacer members 60 are made of the inelastic material, and hence the proper size of each of the clearances S1 can be secured without significantly varying the clearances S1 even if the size of the display device body 10 increases so that the light guide plate 32 becomes heavy. The light guide plate 32 is in contact with the spacer members 60 so as to be movable in the longitudinal direction (direction B) of the light-receiving surface 32a of the light guide plate 32. The upper surface portion 60b of each of the spacer members 60 is planarized. The planarized upper surface portion 60b is in line contact with the light-receiving surface 32a of the light guide plate 32.

According to this embodiment, the light guide plate 32 presses down the spacer members 60 in a vertical direction (direction C1) with prescribed pressing force P by its own weight, as shown in FIG. 6. Thus, the light-receiving surface 32a of the light guide plate 32 is maintained in contact with the upper surface portion 60b of each of the spacer members 60.

As shown in FIGS. 3 and 5, the light guide plate 32 includes an upper end surface 32c formed on a side (C2 side) opposite to the light-receiving surface 32a. This upper end surface 32c extends from one end of the light guide plate 32 to the other end thereof along the direction B (direction perpendicular to the plane of FIG. 3). According to this embodiment, the upper end surface 32c of the light guide plate 32 is separated from the inner surface of the wall portion 22c of the rear chassis 22 located on the upper side (C2 side), opposed to the upper end surface 32c at a prescribed interval D2 in a state where the light guide plate 32 is arranged on the mounting surface 34a of the light source portion 31 through the spacer members 60. In other words, a clearance S2 having the interval D2 is provided. The interval D2 is substantially constant from one end (B2 side) of the light guide plate 32 to the other end (B1 side) thereof. Thus, the upper end surface 32c of the light guide plate 32 can move vertically (in the direction C) in a region where the clearance S2 is provided even if the light guide plate 32 thermally expands by heat generated from the LEDs 35 or the like. The upper end surface 32c is an example of the “second end surface” in the present invention.

As shown in FIG. 5, the end surfaces 32e of the light guide plate 32 in a horizontal direction (direction B) are separated from the inner surface of the wall portion 22c of the rear chassis 22 opposed to the end surfaces 32e at a slight interval. Thus, the light guide plate 32 can expand/contract not only vertically (in the direction C) but also horizontally even if the same thermally expands. More specifically, the light guide plate 32 includes the end surfaces 32e opposed to the inner surface 22d of the rear chassis 22 and extending in a direction (direction C) substantially perpendicular to the light-receiving surface 32a and the upper end surface 32c. The end surfaces 32e of the light guide plate 32 are separated from the inner surface 22d of the rear chassis 22 extending in the direction C, opposed to the end surfaces 32e at a prescribed interval in the state where the light guide plate 32 is arranged on the mounting surface 34a of the light source portion 31 through the spacer members 60. The end surfaces 32e are examples of the “third end surface” in the present invention.

As shown in FIG. 3, the front chassis 21 is formed with a protrusion portion 21f protruding backward (in the direction A2) from the bottom portion 21b along the edge portion of the opening 21a. The top surface 21g of the protrusion portion 21f is in contact with the light-emitting surface 32b of the light guide plate 32 in a state where the rear chassis 22 into which the light guide plate 32 has been incorporated is fixed onto the front chassis 21. Thus, the light guide plate 32 is so held between the bottom portion 22b of the rear chassis 22 and the protrusion portion 21f of the front chassis 21 as to be fixed without rattling. The light guide plate 32 is so held between the rear chassis 22 and the front chassis 21 from the back side (A2 side) and the front side (A1 side) as to be fixed therebetween in a state where the light guide plate 32 is arranged on the mounting surface 34a through the spacer members 60 on the bottom portion 22b of the recess portion 22e of the rear chassis 22. A diffusion sheet 41 and a plurality of lens sheets 42 are stacked successively from the side closer to the light guide plate 32 in the opening 21a of the front chassis 21. Light emitted from the light-emitting surface 32b of the light guide plate 32 is transmitted through the diffusion sheet 41 and the plurality of lens sheets 42, and thereafter reaches the back surface (A2 side) of the liquid crystal panel 40 from the opening 21a. At this time, the light is adjusted to become backlight having a desired luminance and no unevenness of light emission.

As shown in FIG. 2, a mounting portion 12a to mount the leg portion 50a (see FIG. 1) of the stand 50 is integrally provided on the rear cabinet 12. Screw receiving holes (seven screw receiving holes) 12b to receive the screws 91 are provided in the outer periphery of the rear cabinet 12.

According to this embodiment, as hereinabove described, the liquid crystal display device 100 includes the spacer members 60 made of the acrylic resin that is an inelastic material, so arranged as to be in contact with the mounting surface 34a of the light source portion 31 and the light-receiving surface 32a of the light guide plate 32. Thus, the spacer members 60 are made of the inelastic material, and hence the same are not substantially deformed by pressing force received from the light guide plate 32 even if the light guide plate 32 thermally expands by heat generated from the LEDs 35 or the like to generate the outward pressing force. In other words, the distance (height H1 in FIG. 6) between the mounting surface 34a of the light source portion 31 and the light-receiving surface 32a of the light guide plate 32 can be maintained substantially constant due to the spacer members 60 that are not substantially deformed, interposed between the light source portion 31 and the light guide plate 32. Thus, the clearances S1 each including the distance D1, having a substantially constant size can be secured between the emitting surfaces 35b of the LEDs 35 and the light-receiving surface 32a. Furthermore, the spacer members 60 are not substantially deformed, and hence the size of a clearance between the mounting surface 34a of the light source portion 31 and the light-receiving surface 32a of the light guide plate 32 can be properly maintained in response to the dimensions (length×width×thickness) of the light guide plate 32. Thus, the light incidence efficiency of light emitted from the light source portion 31 can be improved. Furthermore, the spacer members 60 render the clearances S1 between the light source portion 31 and the light guide plate 32 proper, and hence the luminance of backlight emitted frontward (in the direction A1) from the light guide plate 32 can be maintained at a proper level while unevenness of light emission of the backlight can be inhibited.

According to this embodiment, the light guide plate 32 is so formed as to press the spacer members 60 made of the inelastic material against the mounting surface 34a of the light source portion 31 by its own weight in a state where the light source portion 31 is arranged below (C1 side) the light guide plate 32. Thus, the pressing force P directed from the light guide plate 32 toward the mounting surface 34a of the light source portion 31 can bring the light-receiving surface 32a of the light guide plate 32 into contact with the spacer members 60 (upper surface portions 60b) without rattling. Furthermore, this pressing force P can bring the spacer members 60 (lower surface portions 60a) into contact with the mounting surface 34a of the light source portion 31 without rattling. Consequently, the clearances S1 each including the distance D1, having the substantially constant size, provided between the emitting surfaces 35b of the light source portion 31 and the light-receiving surface 32a of the light guide plate 32 can be reliably maintained.

According to this embodiment, the weight of the light guide plate 32 is utilized to generate the pressing force P, and hence the pressing force P directed from the light guide plate 32 toward the mounting surface 34a of the light source portion 31 can be easily generated. Furthermore, no urging member or the like to generate the pressing force P may be provided separately, and hence the structure of the display device body 10 can be simplified.

According to this embodiment, the interval D1 between the emitting surfaces 35b of the LEDs 35 and the light-receiving surface 32a of the light guide plate 32 is smaller than the height H2 from the mounting surface 34a to the emitting surfaces 35b of the LEDs 35, whereby light spreading and travelling from the LEDs 35 toward the light guide plate 32 can be inhibited from widely leaking into the sides of the spacer members 60. Thus, the LED light emitted from the LEDs 35 can efficiently enter (be incident on) the light-receiving surface 32a opposed to the emitting surfaces 35b of the LEDs 35.

According to this embodiment, the spacer members 60 are arranged on the end sides of the light guide plate 32 and in the vicinity of the central portion of the light guide plate 32, whereby the light guide plate 32 can be stably supported by the spacer members 60 arranged at least on the end sides of the light guide plate 32 and in the vicinity of the central portion of the light guide plate 32. Therefore, the clearances S1 between the light source portion 31 and the light guide plate 32 can be maintained substantially constant from one end of the light guide plate 32 to the other end thereof.

According to this embodiment, the spacer members 60 are arranged between the LEDs 35, whereby the size of each of clearances between the light source portion 31 and the light guide plate 32 in the direction C can be properly maintained between the LEDs 35.

According to this embodiment, the length of each of the spacer members 60 along the longitudinal direction in which the light-receiving surface 32a of the light guide plate 32 extends is smaller than the length of each of the LEDs 35 along the longitudinal direction. Thus, contact areas between spacer members 60 and the light guide plate 32 can be reduced, and hence some part of light travelling into the light guide plate 32 can be inhibited from being actively reflected on contact interfaces between the light guide plate 32 and the spacer members 60. Consequently, the light reflection on the contact interfaces can be inhibited from influencing the quality (luminance or presence/absence of unevenness of light emission) of the backlight.

According to this embodiment, the light guide plate 32 is in contact with the spacer members 60 so as to be movable in the longitudinal direction of the light-receiving surface 32a of the light guide plate 32, whereby positions of the spacer members 60 with respect to the mounting surface 34a can be inhibited from deviation resulting from deformation of the light guide plate 32 even if the light guide plate 32 thermally expands to be deformed. Thus, the size of each of the clearances S1 between the light source portion 31 and the light guide plate 32 can be properly maintained even if the light guide plate 32 thermally expands to be deformed.

According to this embodiment, the upper end surface 32c of the light guide plate 32 is separated from the inner surface of the wall portion 22c of the rear chassis 22 opposed to the upper end surface 32c at the prescribed interval D2 in the state where the light guide plate 32 is arranged on the mounting surface 34a of the light source portion 31 through the spacer members 60. Thus, the clearance (clearance S2) provided between the upper end surface 32c of the light guide plate 32 and the inner surface of the wall portion 22c can accommodate expansion of the light guide plate 32 even if the light guide plate 32 thermally expands by the heat generated from the LEDs 35 or the like. Consequently, internal stress exceeding a prescribed amount can be inhibited from being generated in the light guide plate 32. Furthermore, the light guide plate 32 can be inhibited from warp or the like resulting from the internal stress.

According to this embodiment, the light guide plate 32 is opposed to the inner surface of the rear chassis 22, the light guide plate 32 further includes the end surfaces 32e extending in the direction substantially perpendicular to the light-receiving surface 32a and the upper end surface 32c, and the end surfaces 32e of the light guide plate 32 are separated from the inner surface of the rear chassis 22 opposed to the end surfaces 32e at the prescribed interval in the state where the light guide plate 32 is arranged on the mounting surface 34a of the light source portion 31 through the spacer members 60. Thus, clearances provided between the end surfaces 32e of the light guide plate 32 and the inner surface of the rear chassis 22 opposed to these end surfaces 32e can accommodate expansion of the light guide plate 32. Consequently, internal stress toward not only the light-receiving surface 32a and the upper end surface 32c of the light guide plate 32 but also the end surfaces 32e of the light guide plate 32, exceeding a prescribed amount can be inhibited from being generated in the light guide plate 32.

According to this embodiment, the liquid crystal display device 100 further includes the front chassis 21 opposed to the front surface of the light guide plate 32 opposite to the back surface of the light guide plate 32 on which the rear chassis 22 is arranged, and the light guide plate 32 is so held between the rear chassis 22 and the front chassis 21 from the back side and the front side as to be fixed therebetween in the state where the light guide plate 32 is arranged on the mounting surface 34a through the spacer members 60 on the bottom portion of the recess portion of the rear chassis 22. Thus, the light guide plate 32 is held between the rear chassis 22 and the front chassis 21 in a state where the clearances S1 between the light source portion 31 and the light guide plate 32 are properly maintained, whereby the position of the light guide plate 32 can be fixed. Consequently, the spacer members 60 can be inhibited from positional deviation resulting from vibration or the like during movement of the liquid crystal display device 100.

According to this embodiment, the upper surface portion 60b of each of the spacer members 60 is planarized, and the planarized upper surface portion 60b is in line contact with the light-receiving surface 32a of the light guide plate 32. Thus, the spacer members 60 and the light guide plate 32 can be reliably brought into line contact with each other, whereby the clearances S1 between the light source portion 31 and the light guide plate 32 can be reliably secured.

According to this embodiment, the length W3 of each of the spacer members 60 along the short-side direction orthogonal to the longitudinal direction of the light-receiving surface 32a of the light guide plate 32 is substantially equal to the thickness t1 of the light guide plate 32. Thus, the overall light-receiving surface 32a of the light guide plate 32 can be supported by the spacer members 60 along the short-side direction orthogonal to the longitudinal direction of the light-receiving surface 32a of the light guide plate 32, and hence the clearances S1 between the light source portion 31 and the light guide plate 32 can be properly maintained along not only the longitudinal direction but also the short-side direction.

According to this embodiment, the upper surface portion 60b of each of the spacer members 60 is in direct contact with the light-receiving surface 32a of the light guide plate 32 in a state where the lower surface portion 60a of each of the spacer members 60 is bonded onto the mounting surface 34a of the light source portion 31 through the double-faced adhesive tape 5. Thus, each of the spacer members 60 previously bonded onto the mounting surface 34a of the light source portion 31 through the double-faced adhesive tape 5 can be easily brought into contact with the light-receiving surface 32a of the light guide plate 32 so that the liquid crystal display device 100 can be easily assembled, and hence an operation of assembling the liquid crystal display device 100 can be simplified.

Although the present invention has been described and illustrated in detail, it is clearly understood that the same is by way of illustration and example only and is not to be taken by way of limitation, the spirit and scope of the present invention being limited only by the terms of the appended claims.

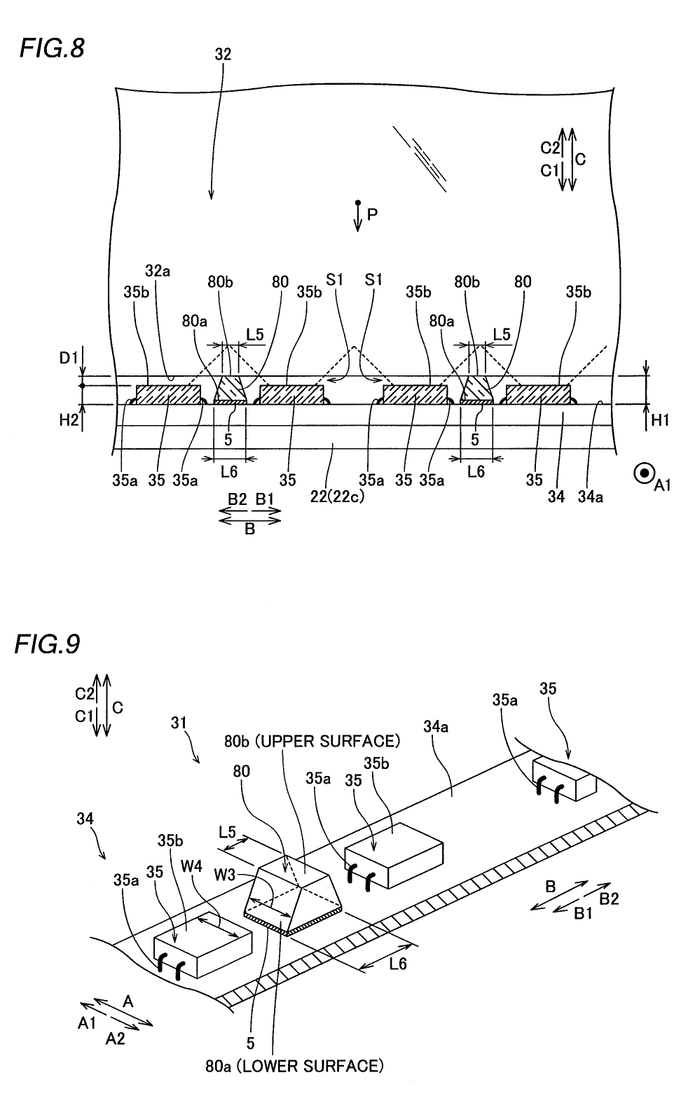

For example, while the spacer members 60 each are formed in a substantially rectangular parallelepiped shape in the aforementioned embodiment, the present invention is not restricted to this. For example, spacer members 80 each having a trapezoidally shaped cross-section may alternatively be employed, as in a first modification shown in FIGS. 8 and 9. More specifically, the spacer members 80 each have the trapezoidally shaped cross-section as viewed along the short-side direction (direction A) orthogonal to the longitudinal direction (direction B) in which the light-receiving surface 32a of the light guide plate 32 extends, as shown in FIG. 8. In other words, the length L5 of the upper surface portion 80b of each of the spacer members 80 in the direction B is smaller than the length L6 of the lower surface portion 80a of each of the spacer members 80 in the direction B (L5<L6). The dimension W3 of each of the spacer members 80 in the direction A is substantially constant along the direction A. Therefore, a contact area between the upper surface portion 80b and a light-receiving surface 32a is smaller than a contact area between the lower surface portion 80a and a mounting surface 34a. The lower surface portion 80a and the upper surface portion 80b are examples of the “arrangement portion” and the “contact portion” in the present invention, respectively.

According to the structure of the first modification, each of the spacer members 80 can be stably arranged on the mounting surface 34a of a glass epoxy board 34 through the larger contact area. Furthermore, each of the spacer members 80 can be brought into contact with the light-receiving surface 32a of a light guide plate 32 through the smaller contact area. Thus, some part of light travelling into the light guide plate 32 can be easily inhibited from being actively reflected on a contact interface between the light-receiving surface 32a and the upper surface portion 80b of each of the spacer members 80. Consequently, the light reflection on the contact interface can be inhibited from influencing the quality (luminance or presence/absence of unevenness of light emission) of backlight.

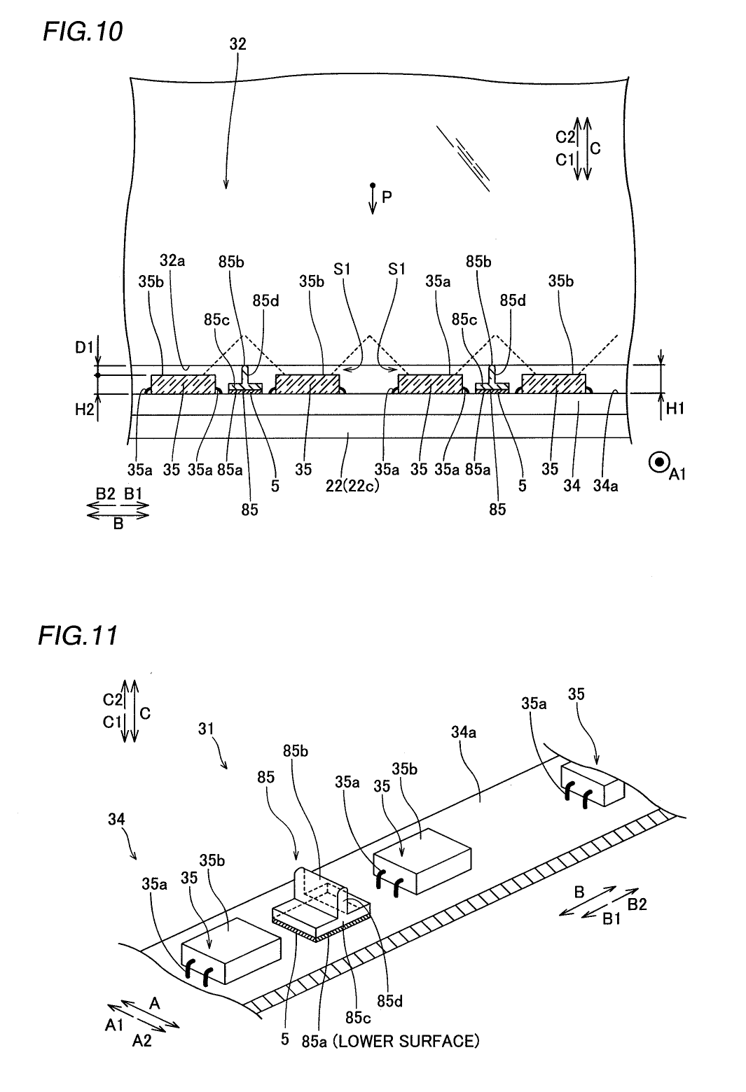

While the spacer members 80 each have the trapezoidally shaped cross-section in the aforementioned first modification, the present invention is not restricted to this. For example, spacer members 85 each having a T-shaped cross-section may alternatively be employed, as in a second modification shown in FIGS. 10 and 11. More specifically, the spacer members 85 each have an inverted T-shaped cross-section as viewed along the short-side direction (direction A) orthogonal to the longitudinal direction (direction B) in which the light-receiving surface 32a of the light guide plate 32 extends, as shown in FIG. 10. In other words, the spacer members 85 each include a base portion 85c having a flat lower surface portion 85a in contact with a mounting surface 34a of a glass epoxy board 34 and a single rib 85d extending upward (in a direction C2) from a substantially central portion of the base portion 85c in a longitudinal direction. A tip portion 85b of the rib 85d has a curved surface, and the light-receiving surface 32a of the light guide plate 32 is in contact with the tip portion 85b having the curved surface. The rib 85d and the tip portion 85b substantially linearly extend along the direction A that is the thickness direction of the light guide plate 32. The tip portion 85b is provided on the tip of the rib 85d extending from the lower surface portion 85a toward the light-receiving surface 32a of the light guide plate 32. Therefore, a contact area between the tip portion 85b and the light-receiving surface 32a is very small as compared with a contact area between the lower surface portion 85a and the mounting surface 34a. The lower surface portion 85a and the tip portion 85b are examples of the “arrangement portion” and the “contact portion” in the present invention, respectively. The spacer members 85 may be made of an acrylic resin or a metallic material such as aluminum. The rib 85d is an example of the “support portion” in the present invention.

According to the structure of the second modification, each of the spacer members 85 can be brought into contact with the light-receiving surface 32a of the light guide plate 32 through the smaller contact area. Thus, some part of light travelling into the light guide plate 32 can be further inhibited from being actively reflected on a contact interface between the light-receiving surface 32a and the tip portion 85b of each of the spacer members 85.

While the light guide plate 32 is so formed as to press the spacer members 60 against the mounting surface 34a of the light source portion 31 by its own weight in a state where the light source portion 31 is mounted on the lower side (C1 side) of the rear chassis 22 in the aforementioned embodiment, the present invention is not restricted to this. For example, the light guide plate may alternatively be so formed as to be urged in the direction B2 against the mounting surface of the board portion through the spacer members in a state where the board portion (light source portion) is mounted on one side (B2 side, for example) of the rear chassis 22 in the horizontal direction (direction B in FIG. 5). In this case, a clearance extending in the vertical direction is preferably provided between the end surface of the light guide plate and the wall portion 22c of the rear chassis 22 on the other side (B1 side, for example) of the rear chassis 22 in the horizontal direction, and an urging member such as a spring member is preferably incorporated in this clearance. The light guide plate is urged against the spacer members and the board portion (mounting surface) with urging force of this urging member in the direction B2. Also according to the structure of a liquid crystal display device in this modification, the effects of the present invention can be easily obtained.

While the lower surface portion 60a of each of the spacer members 60 is bonded onto the mounting surface 34a of the glass epoxy board 34 by the double-faced adhesive tape 5 in the aforementioned embodiment, the present invention is not restricted to this. For example, the light guide plate 32 may alternatively be placed on the glass epoxy board 34 in a state where the upper surface portion 60b of each of the spacer members 60 is previously bonded onto the light-receiving surface 32a of the light guide plate 32 by the double-faced adhesive tape. In this case, the lower surface portion 60a of each of the spacer members 60 is in direct contact with the mounting surface 34a of the glass epoxy board 34.

While the spacer members 60 are fixed onto the mounting surface 34a of the glass epoxy board 34 with the double-faced adhesive tape 5 in the aforementioned embodiment, the present invention is not restricted to this. For example, the spacer members 60 may alternatively be fixed onto the mounting surface 34a with an adhesive or the like. Alternatively, the spacer members may be fixed onto the mounting surface of the board portion with a screw member or the like other than the “bonding layer” in the present invention.

While the spacer members 60 are made of the transparent acrylic resin allowing transmission of light in the aforementioned embodiment, the present invention is not restricted to this. For example, the spacer members may alternatively be made of an inelastic material not allowing transmission of light. Furthermore, while no treatment has been performed on the side surface portions of each of the spacer members 60 other than the lower surface portion 60a and the upper surface portion 60b, the present invention is not restricted to this. For example, reflective sheets or the like may alternatively be applied to the side surface portions of each of the spacer members. In other words, light leaking from the light guide plate can be properly reflected by the reflective sheets applied to the spacer members. Thus, an unexpected adverse effect such as unevenness of light emission, caused by inclusion of the spacer members can be properly dealt with also when the spacer members are provided between the board portion and the light guide plate.

While the cross-section of each of the spacer members 80 is trapezoidally shaped as viewed along the short-side direction (direction A) in the aforementioned first modification of the embodiment, the present invention is not restricted to this. For example, the length L5 of the upper surface portion 80b of each of the spacer members 80 in the direction B may alternatively be further reduced. Thus, the cross-section of each of the spacer members may be substantially triangularly shaped. Consequently, each of the spacer members can be brought into contact with the light-receiving surface 32a of the light guide plate 32 through a smaller contact area.

While the spacer members 85 each have the single rib 85d extending upward from the substantially central portion of the base portion 85c in the longitudinal direction in the aforementioned second modification of the embodiment, the present invention is not restricted to this. For example, two or more ribs may alternatively extend from the substantially central portion of the base portion 85c. Furthermore, while the rib 85d substantially linearly extends along the direction A (see FIG. 11) that is the thickness direction of the light guide plate 32 in the second modification of the aforementioned embodiment, the present invention is not restricted to this. The rib 85d may alternatively extend obliquely along the diagonal line (directions A and B) of the lower surface portion 85a. Thus, the rib 85d obliquely extends so that a contact area between the tip portion 85b and the light-receiving surface 32a can be rendered larger than the contact area between the tip portion 85b and the light-receiving surface 32a in the case of the rib extending only in the direction A as in the aforementioned second modification. Consequently, the light guide plate 32 can be more stably supported even if the spacer members each having the T-shaped cross-section are employed.

While the length W3 of each of the spacer members 60 in the short-side direction (direction A) is substantially equal to the width W4 of each of the LEDs 35 in the direction A in the aforementioned embodiment, the present invention is not restricted to this. For example, the length W3 of each of the spacer members 60 in the short-side direction (direction A) may alternatively be substantially equal to the thickness t1 of the light-receiving surface 32a of the light guide plate 32. Alternatively, the length W3 of each of the spacer members 60 in the short-side direction (direction A) may be different in size from the width W4 of each of the LEDs 35 and the thickness t1 of the light guide plate 32.

While the “liquid crystal display device” according to the present invention is applied to the liquid crystal television set having a TV tuner function, the liquid crystal display monitor connected to a PC or the like, or the like in the aforementioned embodiment, the present invention is not restricted to this. For example, the “liquid crystal display device” according to the present invention may alternatively be applied to a liquid crystal display monitor loaded into a car navigation system, an information display monitor (liquid crystal display monitor) loaded into a train, a bus, a ship, an airplane, or the like.

While the interval D1 between the emitting surfaces 35b of the LEDs 35 and the light-receiving surface 32a of the light guide plate 32 is smaller than the height H2 from the mounting surface 34a to the emitting surfaces 35b of the LEDs 35 in the aforementioned embodiment, the present invention is not restricted to this. In the present invention, the interval D1 between the emitting surfaces 35b of the LEDs 35 and the light-receiving surface 32a of the light guide plate 32 may alternatively be not less than the height H2 from the mounting surface 34a to the emitting surfaces 35b of the LEDs 35.

While the spacer members 60 each are arranged in every other position between the adjacent LEDs 35 in the aforementioned embodiment, the present invention is not restricted to this. In the present invention, the spacer members each may alternatively be arranged in every third position or fourth position and so on between the adjacent LEDs 35 or arranged in every position between the adjacent LEDs 35.

While the length W3 of each of the spacer members 60 along the short-side direction orthogonal to the longitudinal direction of the light-receiving surface 32a of the light guide plate 32 is substantially equal to the thickness t1 of the light guide plate 32 in the aforementioned embodiment, the present invention is not restricted to this. In the present invention, the length W3 of each of the spacer members 60 along the short-side direction orthogonal to the longitudinal direction of the light-receiving surface 32a of the light guide plate 32 may alternatively be larger than the thickness t1 of the light guide plate 32.

While the liquid crystal panel 40 is employed as the example of the display portion according to the present invention in the aforementioned embodiment, the present invention is not restricted to this. In the present invention, a display portion other than the liquid crystal panel 40 may alternatively be employed.

What is claimed is:

1. A liquid crystal display device comprising:
a display portion;
a board portion having a mounting surface on which light sources are mounted;
a light guide plate including a first end surface receiving light from said light sources, guiding said light received from said first end surface to said display portion; and
spacer members made of an inelastic material, so arranged as to be in contact with said mounting surface of said board portion and said first end surface of said light guide plate.

2. The liquid crystal display device according to claim 1, wherein
said light guide plate is so formed as to press said spacer members made of said inelastic material against said mounting surface of said board portion.

3. The liquid crystal display device according to claim 2, wherein
said board portion is arranged below said light guide plate, and
said light guide plate is so formed as to press said spacer members made of said inelastic material against said mounting surface of said board portion by its own weight.

4. The liquid crystal display device according to claim 1, wherein
each of said light sources has a light-emitting surface on a side opposed to said first end surface of said light guide plate, and
an interval between said light-emitting surface of each of said light sources and said first end surface of said light guide plate is smaller than a height from said mounting surface to said light-emitting surface of each of said light sources.

5. The liquid crystal display device according to claim 1, wherein
said spacer members are arranged on end sides of said light guide plate and in a vicinity of a central portion of said light guide plate.

6. The liquid crystal display device according to claim 1, wherein
each of said spacer members is arranged between said light sources.

7. The liquid crystal display device according to claim 1, wherein
a length of each of said spacer members along a longitudinal direction in which said first end surface of said light guide plate extends is smaller than a length of each of said light sources along said longitudinal direction.

8. The liquid crystal display device according to claim 1, wherein
said light guide plate is in contact with said spacer members so as to be movable in a longitudinal direction of said first end surface of said light guide plate.

9. The liquid crystal display device according to claim 1, further comprising a first chassis including a recess portion surrounded by an inner surface of said first chassis, holding said board portion and said light guide plate on a bottom surface of said recess portion, wherein
said light guide plate further includes a second end surface formed on a side opposite to said first end surface, and
said second end surface of said light guide plate is separated from said inner surface of said first chassis opposed to said second end surface at a prescribed interval in a state where said light guide plate is arranged on said mounting surface of said board portion through said spacer members.

10. The liquid crystal display device according to claim 9, wherein
said light guide plate further includes a third end surface extending in a direction substantially perpendicular to said first end surface and said second end surface, opposed to said inner surface of said first chassis, and
said third end surface of said light guide plate is separated from said inner surface of said first chassis opposed to said third end surface at a prescribed interval in the state where said light guide plate is arranged on said mounting surface of said board portion through said spacer members.

11. The liquid crystal display device according to claim 9, further comprising a second chassis opposed to a front surface of said light guide plate opposite to a back surface of said light guide plate on which said first chassis is arranged, wherein
said light guide plate is so held between said first chassis and said second chassis from a side of said back surface and a side of said front surface as to be fixed between said first chassis and said second chassis in a state where said light guide plate is arranged on said mounting surface through said spacer members on said bottom portion of said recess portion of said first chassis.

12. The liquid crystal display device according to claim 1, wherein
each of said spacer members includes an arrangement portion arranged on said mounting surface of said board portion and a contact portion in contact with said first end surface of said light guide plate, and
a contact area between said contact portion and said first end surface is smaller than an area of said arrangement portion.

13. The liquid crystal display device according to claim 12, wherein
said mounting surface of said board portion extends along a longitudinal direction in which said first end surface of said light guide plate extends, and
a length of said contact portion of each of said spacer members in said longitudinal direction is smaller than a length of said arrangement portion of each of said spacer members in said longitudinal direction.

14. The liquid crystal display device according to claim 12, wherein
said contact portion of each of said spacer members is planarized, and
planarized said contact portion is in line contact with said first end surface of said light guide plate.

15. The liquid crystal display device according to claim 13, wherein
a length of each of said spacer members along a short-side direction orthogonal to said longitudinal direction of said first end surface of said light guide plate is substantially equal to or larger than a thickness of said light guide plate along said short-side direction.

16. The liquid crystal display device according to claim 12, wherein
each of said spacer members has a trapezoidally shaped or triangularly shaped cross-section as viewed along a short-side direction orthogonal to a longitudinal direction in which said first end surface of said light guide plate extends.

17. The liquid crystal display device according to claim 12, wherein
each of said spacer members has an inverted T-shaped cross-section as viewed along a short-side direction orthogonal to a longitudinal direction of said light guide plate, and
said contact portion is provided on a tip of a support portion extending from said arrangement portion toward said first end surface of said light guide plate.

18. The liquid crystal display device according to claim 1, wherein
said spacer members are in direct contact with either one of said mounting surface of said board portion and said first end surface of said light guide plate while each of said spacer members is bonded to the other one of said mounting surface of said board portion and said first end surface of said light guide plate through a bonding layer.

19. A liquid crystal television set comprising:
a receiving portion receiving a television broadcast signal;
a display portion displaying an image on the basis of said television broadcast signal received by said receiving portion;
a board portion having a mounting surface on which light sources are mounted;
a light guide plate including a first end surface receiving light from said light sources, guiding said light received from said first end surface to said display portion; and
spacer members made of an inelastic material, so arranged as to be in contact with said mounting surface of said board portion and said first end surface of said light guide plate.

20. A television set comprising:
a receiving portion receiving a television broadcast signal;
a display portion displaying an image on the basis of said television broadcast signal received by said receiving portion;
a board portion having a mounting surface on which light sources are mounted;
a light guide plate including a first end surface receiving light from said light sources, guiding said light received from said first end surface to said display portion; and
spacer members made of an inelastic material, so arranged as to be in contact with said mounting surface of said board portion and said first end surface of said light guide plate.
